(19) United States
(12) Patent Application Publication
(10) Pub. No.: US 2025/0356389 A1
(43) Pub. Date: Nov. 20, 2025

(54) INFORMATION PROCESSING APPARATUS, INFORMATION PROCESSING METHOD, AND INFORMATION PROCESSING PROGRAM

(71) Applicant: Nippon Telegraph and Telephone Corporation, Tokyo (JP)

(72) Inventors: Hideaki KIN, Musashino-shi, Tokyo (JP); Tetsuya KINEBUCHI, Musashino-shi, Tokyo (JP); Taichi ASAMI, Musashino-shi, Tokyo (JP)

(21) Appl. No.: 18/871,687

(22) PCT Filed: Jun. 14, 2022
(86) PCT No.: PCT/JP2022/023747

§ 371 Date: Dec. 4, 2024

(51) Int. Cl. G06Q 30/0207; G06F 17/11

(52) U.S. Cl. CPC G06Q 30/0224; G06F 17/11

(57) ABSTRACT

According to one embodiment, an information processing apparatus includes: an acquisition unit configured to acquire behavior history data and a condition for optimizing an incentive policy for each of users; a parameter estimation unit configured to estimate a parameter value of a behavior model for each user based on the behavior history data, the behavior model having a success stock indicating a psychological accumulated amount of past success experiences as an internal variable; an optimization unit configured to calculate an optimal incentive policy for each user based on the estimated parameter value and the condition; and an output unit configured to output the optimal incentive policy.

### TECHNICAL FIELD

The present invention relates to an information processing apparatus, an information processing method, and an information processing program.

### BACKGROUND ART

In order to achieve a certain goal-oriented behavior, it is conceivable to provide incentives and accomplish the goal-oriented behavior through those incentives.

In NPL 1, achievement of a target behavior by incentives or formation of a target habit is described. For example, 1 discloses that with the aim of the formation of exercise habits, formation of exercise habits in people can be promoted by providing incentives (money) based on an amount of exercise. NPL 2 discloses that an effect of incentives differs depending on a method of giving the incentives.

### CITATION LIST

### Non Patent Literature

[NPL 1] Finkelstein, Eric. A., et al., “A Randomized Study of Financial Incentives to Increase Physical Activity among Sedentary Older Adults”, Preventive medicine, 47(2), pp. 182 to 187, 2008.

[NPL 2] Bachireddy Chethan, et al., “Effect of Different Financial Incentive Structures on Promoting Physical Activity Among Adults: A Randomized Clinical Trial”, JAMA Network Open, 2(8), pp. 1 to 13, 2019.

### SUMMARY OF INVENTION

### Technical Problem

In the achievement of a certain target behavior, magnitude of an effect of an incentive amount varies for each individual irrespective of the same incentives. However, in the technologies of the related art, individual response differences to incentives are not taken into account. Therefore, the incentives may be likely not to be utilized effectively for each person. In the technologies of the related art, it is assumed that an amount of an incentive given at each of times (daily, weekly, or the like) is constant, monotonously decreases, or monotonously increases, but it is thought that the effect of incentives also varies in accordance with internal states of people that vary daily. Therefore, in a simple incentive giving method, it may be difficult to effectively manage incentives.

For an operator who implement interventions through incentives, incentives (such as cash or coupons) are directly associated with cost. Thus, it is desirable to achieve high cost-effectiveness meaning achievement of significant effects with fewer incentives.

In view of the foregoing circumstances, an object of the present invention is to provide a technique capable of specifying, for each individual, an incentive policy that is highly cost-effective in order to maintain a target behavior.

### Solution to Problem

In order to solve the above problem, according to an aspect of the present invention, an information processing apparatus includes: an acquisition unit configured to acquire behavior history data and a condition for optimizing an incentive policy for each of users; a parameter estimation unit configured to estimate a parameter value of a behavior model for each user based on the behavior history data, the behavior model having a success stock indicating a psychological accumulated amount of past success experiences as an internal variable; an optimization unit configured to calculate an optimal incentive policy for each user based on the estimated parameter value and the condition; and an output unit configured to output the optimal incentive policy.

### Advantageous Effects of Invention

According to an aspect of the present invention, it is possible to specify, for each individual, an incentive policy that is highly cost-effective in order to maintain a target behavior. A business operator can support achievement of a target behavior for each user at lower cost by using a cost-effective incentive policy. Accordingly, the business operator can expand profits or set low service usage fees.

### BRIEF DESCRIPTION OF DRAWINGS

FIG. 1 is a block diagram illustrating an example of a hardware configuration of an information processing apparatus according to a first embodiment.

FIG. 2 is a block diagram illustrating a software configuration of the information processing apparatus according to the first embodiment in association with the hardware configuration illustrated in FIG. 1.

FIG. 3 is a flowchart illustrating an example of a parameter estimation operation of the information processing apparatus.

FIG. 4 is a flowchart illustrating an example of an operation of calculating an optimum incentive policy of the information processing apparatus.

### DESCRIPTION OF EMBODIMENTS

Hereinafter, embodiments of the present invention will be described below with reference to the drawings.

Hereinafter, elements that are the same as or similar to elements that have already been described are denoted by the same or similar reference signs, and repeated description will be basically omitted.

First, in a social cognitive theory research, it has been reported that a probability of achievement of a target behavior is improved with high self-efficacy. Here, self-efficacy means that a human recognizes that the human has ability to achieve a goal. That is, the self-efficacy refers to a state in which it is believed that a target can be achieved on one's own. Past goal achievement experiences have been reported to enhance self-efficacy. That is, achievement of the target behavior (for example, achievement of 10,000 steps per day) induces further achievement in target behavior through self-efficacy. Accordingly, when the goal is achieved, self-efficacy is increased.

On the other hand, in the case of a human who has a personal reference value in relation to a frequency of the achievement of the target behavior, the achievement of a target behavior does not necessarily always induce the achievement of further goal behaviors and may lead to a temporary decline in motivation for subsequent target behaviors. For example, in the case of an aim to continue walking 10,000 steps per day, a person walking 30,000 steps per week as a reference value may achieve a number of steps close to 30,000 steps in the middle of the week and then in the latter half of the week, it is conceivable that the number of steps per day will decrease. Conversely, when the number of steps is less than 10,000 in the middle of the week, it is conceivable that the number of steps per day will be actively increased in the latter half of the week.

That is, the personal reference value related to a frequency of achievement of the target behavior has the effect of bringing the human behavior close to the reference value. This effect will be hereinafter referred to as a self-restoring effect. For example, due to the self-restoration effect, when a human has achieved near a reference value in the first half of a predetermined period of time, they may not tray to achieve the target behavior in the second half, but on the other hand, when only a value far from the reference value achievement is achieved in the first half of the predetermined period, the target behavior is positively achieved in the second half.

In the present invention, in construction of a mathematical model (hereinafter referred to as a behavior model) in which incentives are input and an achievement for the target behavior is output, an incentive giving method is determined based on the behavior model in consideration of the self-efficacy and the self-restoration effect to solve the foregoing problems.

### Embodiment

### (Configuration)

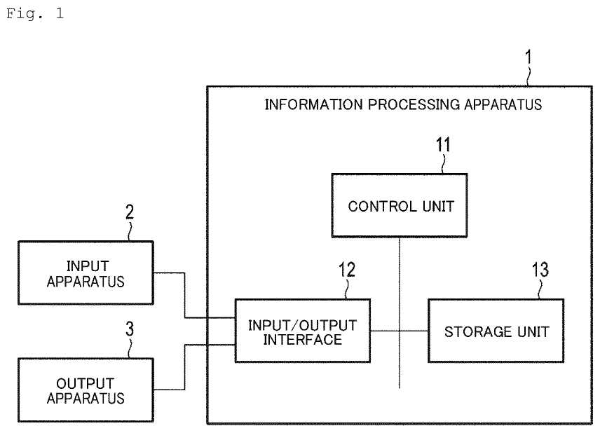

FIG. 1 is a block diagram illustrating an example of a hardware configuration of an information processing apparatus 1 according to a first embodiment.

The information processing apparatus 1 is implemented by a computer such as a personal computer (PC). The information processing apparatus 1 includes a control unit 11, an input/output interface 12, and a storage unit 13. The control unit 11, the input/output interface 12, and the storage unit 13 are communicatively connected to each other via a bus.

The control unit 11 controls the information processing apparatus 1. The control unit 11 includes a hardware processor such as a central processing unit (CPU).

The input/output interface 12 is an interface that enables information to be transmitted and received between the input apparatus 2 and the output apparatus 3. The input/output interface 12 may include a wired or wireless communication interface. That is, the information processing apparatus 1, the input apparatus 2, and the output apparatus 3 may transmit and receive information via a network such as a LAN or the Internet.

The storage unit 13 is a storage medium. The storage unit 13 includes, for example, a combination of a nonvolatile memory such as a hard disk drive (HDD) or a solid state drive (SSD) capable of performing writing and reading at any time, a nonvolatile memory such as a read only memory (ROM), and a volatile memory such as a random access memory (RAM). The storage unit 13 has a program storage area and a data storage area in a storage area. The program storage area stores an operating system (OS), middleware, and an application program necessary to execute various types of processing.

The input apparatus 2 includes, for example, a keyboard or a pointing device for an owner of the information processing apparatus 1 (for example, an allocator, an administrator, or a supervisor) inputting instructions to the information processing apparatus 1. The input apparatus 2 may include a reader that reads data to be stored in the storage unit 13 from a memory medium such as a USB memory, and a disk device for reading such data from a disk medium. Further, the input apparatus 2 may include an image scanner.

The output apparatus 3 includes a display which displays output data to be presented to the owner from the information processing apparatus 1 and a printer which prints the output data. The output apparatus 3 includes a writer that writes data to be input to another information processing apparatus 1 such as a PC or a smartphone on a memory medium such as a USB memory, or a disk device that writes such data to a disk medium.

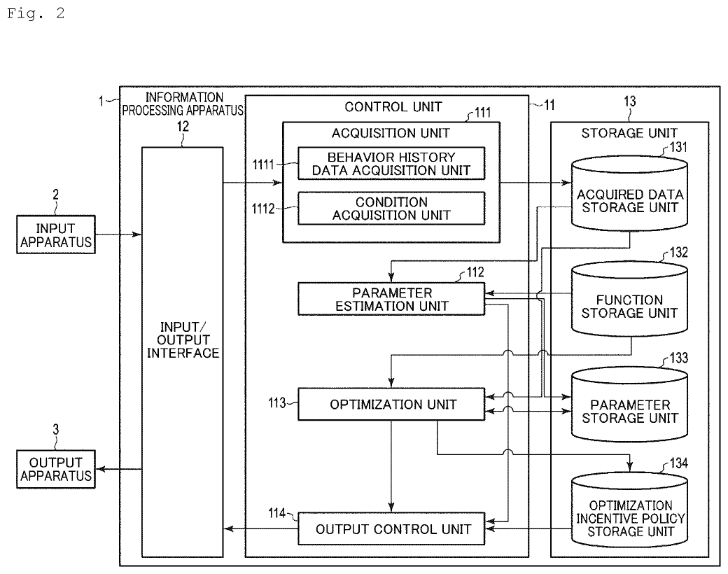

FIG. 2 is a block diagram illustrating a software configuration of the information processing apparatus 1 according to the first embodiment in association with the hardware configuration illustrated in FIG. 1.

The storage unit 13 includes an acquired data storage unit 131, a parameter storage unit 132, and an optimization incentive policy storage unit 133.

The acquired data storage unit 131 stores various types of data acquired by an acquisition unit 111 of the control unit 11 to be described below. The data stored in the acquired data storage unit 131 may be data acquired by obtaining the behavior history data, a condition, and the like from the outside via the input apparatus 2 or may include data generated by the control unit 11. The behavior history data and the condition will be described below.

The parameter storage unit 132 stores the parameter values of the behavior model estimated by a parameter estimation unit 112 to be described below. The behavior model and the parameter values of the behavior model will be described below.

The optimization incentive policy storage unit 133 stores the optimal incentive policy calculated by an optimization unit 113 to be described below. The optimal incentive policy will be described below.

The control unit 11 includes the acquisition unit 111, the parameter estimation unit 112, the optimization unit 113, and an output control unit 114. These functional units are implemented by the hardware processor executing an application program stored in the storage unit 13.

The acquisition unit 111 acquires necessary data and stores the data in the acquired data storage unit 131. The acquisition unit 111 includes a behavior history data acquisition unit 1111 and a condition acquisition unit 1112.

The behavior history data acquisition unit 1111 acquires behavior history data for each user from the input apparatus 2 via the input/output interface 12, and stores the acquired behavior history data in an acquired data storage unit 131. The behavior history data acquisition unit 1111 may separately acquire behavior history data of one user, or may acquire a behavior history of a plurality of users at a time in a form that can be distinguished from each other. The behavior history data acquisition unit 1111 may output a signal indicating that the behavior history data is acquired to the parameter estimation unit 112. The acquired behavior history data will be described below.

The condition acquisition unit 1112 acquires the condition for each user from the input apparatus 2 via the input/output interface 12 and stores the acquired condition in the acquired data storage unit 131. The condition acquisition unit 1112 may also acquire the condition for one user separately or may acquire the condition for a plurality of users at a time in a form that can be distinguished from each other. The condition acquisition unit 1112 may output a signal indicating that the condition has been acquired to the optimization unit 113. The acquired condition will be described below.

The parameter estimation unit 112 estimates, for each user, a parameter value of a mathematical model (behavior model) that receives an incentive amount as an input and outputs an achievement for a target behavior based on the behavior history data stored in the acquired data storage unit 131. Further, the parameter estimation unit 112 stores the estimated parameter value in the parameter storage unit 132. Here, the incentive amount, the target behavior, and the behavior model will be described below.

The optimization unit 113 calculates an optimal incentive policy based on the parameter value estimated by the parameter estimation unit 112 and the condition stored in the acquired data storage unit 131. The optimization unit 113 calculates the optimal incentive policy for each user. The optimization unit 113 stores the calculated optimal incentive policy in the optimization incentive policy storage unit 133. The details of the optimum incentive policy will be described below.

The output control unit 114 estimates a parameter value for any user based on the behavior history data of the user, and then outputs the optimization incentive policy stored in the optimization incentive policy storage unit 133 to the output apparatus 3 via the input/output interface 12 in response to the acquisition of the condition from the input apparatus 2. The output control unit 114 may calculate the optimal incentive policy based on the parameter value and the condition for any user, and then may output the optimal incentive policy for any user stored in the optimization incentive policy storage unit 133 to the output apparatus 3 via the input/output interface 12 in response to an operation of the user of the information processing apparatus 1.

### (Operation)

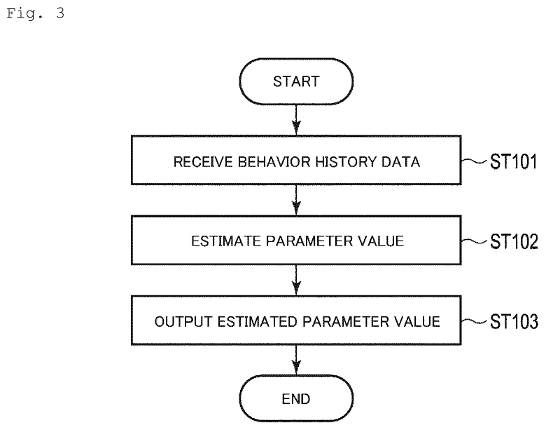

FIG. 3 is a flowchart illustrating an example of a parameter estimation operation of the information processing apparatus 1.

The control unit 11 of the information processing apparatus 1 implements an operation of the flowchart by reading and executing a program stored in the storage unit 13.

The operation may start at any timing. For example, the operation may start automatically at each constant time or may start using an operation of an owner of the information processing apparatus 1 as a trigger.

In step ST101, the behavior history data acquisition unit 1111 acquires the behavior history data from the input apparatus 2 via the input/output interface 12. For example, the user may input the behavior history data to the input apparatus 2. Alternatively, the behavior history data acquisition unit 1111 may acquire behavior history data stored in an external server or the like via the input/output interface 12. The behavior history data acquisition unit 1111 stores the acquired behavior history data in the acquired data storage unit 131. The behavior history data acquisition unit 1111 may output a signal indicating that the behavior history data has been acquired to the parameter estimation unit 112. Alternatively, the behavior history data acquisition unit 1111 may output the behavior history data to the parameter estimation unit 112.

Here, the behavior history data includes various types of information at each observation time for each user. For example, the behavior history data includes a user ID (hereinafter referred to as u), a total number of users (hereinafter referred to as U), a length of a period of an aimed behavior (target behavior) of a user u (hereinafter referred to as T^{u}), a sequence of observed values of the target behavior at each observation time of the user u (hereinafter referred to as the following formula).

$$\{ {y}_{t}^{u} \} ≡ ( {y}_{1}^{u} , {y}_{2}^{u} , … , {y}_{{T}^{u}}^{u} ) \qquad [ Math . 1 ]$$

A series of incentive amounts presented at each observation time of the user u (hereinafter referred to as the following formula).

$$\{ {a}_{t}^{u} \} ≡ ( {a}_{1}^{u} , {a}_{2}^{u} , … , {a}_{{T}^{u}}^{u} ) \qquad [ Math . 2 ]$$

A sequence of explanatory variables at each observation time of the user u (hereinafter referred to as the following formula).

$$\{ {e}_{t}^{u} \} ≡ ( {e}_{1}^{u} , {e}_{2}^{u} , … , {e}_{{T}^{u}}^{u} ) \qquad [ Math . 3 ]$$

Here, the observed value {y^{u}ₜ} of the target behavior is a numerical value for evaluating success or failure of the aimed behavior and it is assumed to take 0 (failure) or 1 (success). Further, the explanatory variable {e^{u}ₜ} is a day of the week, weather, or the like and is information which can have an influence on the target behavior of the user other than the incentives. An incentive amount {a^{u}ₜ} may be, for example, money or points. The behavior history data may be, for example, data of a result obtained by acquiring the above-described information for each user using a behavior observation device or the like including a sensor.

In step ST102, the parameter estimation unit 112 estimates the parameter value. When a signal indicating that the behavior history data has been acquired from the behavior history data acquisition unit 1111 is received, the parameter estimation unit 112 acquires the behavior history data stored in the acquired data storage unit 131. When the behavior history data is directly received from the behavior history data acquisition unit 1111, the parameter estimation unit 112 may use the received behavior history data. The parameter estimation unit 112 estimates the parameter value of the behavior model for each user u for receiving the incentive amount included in the behavior history data as an input and outputting an achievement of the target behavior.

The behavior model has a success stock (hereinafter referred to as x^{u}ₜ) as an internal variable. The success stock is a psychological accumulated amount of a past success experience and is attenuated with time to follow the following formula.

$$[ Math . 4 ]$$

$${x}_{t + 1}^{u} = ( 1 - {β}^{u} ) {x}_{t}^{u} + {β}^{u} {y}_{t}^{u} \qquad ( 1 )$$

Here, β^{u} represents a forgetting rate. The forgetting rate is, for example, a value indicating how much the once stored data can be stored over time. In Formula (1), the success stock at a next observation time becomes larger as the interval from a present observation time becomes shorter. The success stock is added when the target behavior is achieved (successful). When an internal variable (hereinafter referred to as m^{u}ₜ) for determining a probability of success or failure of the target behavior is referred to as motivation, the motivation is determined by the success stock, the incentive amount to be presented, and the explanatory variables and can be represented as follows.

$$[ Math . 5 ]$$

$${m}_{t}^{u} = k ( {x}_{t}^{u} \vert {θ}_{x}^{u} ) + h ( {a}_{t}^{u} \vert {θ}_{h}^{u} ) + g ( {e}_{t}^{u} \vert {θ}_{e}^{u} ) . \qquad ( 2 )$$

Here, h(a^{u}ₜ|θ^{u}ₕ) is a function representing sensitivity to the incentive amount of the user u, and has a parameter value θ^{u}ₕ. In addition, g(e^{u}ₜ|θ^{u}ₑ) is a function representing an influence of the user u on the explanatory variable and has a parameter value θ^{u}ₑ. Furthermore, k(x^{u}ₜ|θ^{u}ₑ) is a function representing an influence of the user u on the success stock and has the parameter value θ^{u}ₑ. The self-efficacy and the self-restoration effect are implemented in the behavior model via k(x^{u}ₜ|θ^{u}ₓ). For example, when k(x^{u}ₜ|θ^{u}ₓ) is a monotonous increasing function, the higher the past success frequency is, the higher the motivation is. The behavior model becomes a model in which the self-efficacy is reflected. When the function is a function changing from an increase to a decrease using a certain success stock value as a boundary, the behavior model is a model in which the self-restoring effect is reflected. Alternatively, when the function is a function changing from a decrease to an increase using a certain success stock value as a boundary, the behavior model is a model in which the self-restoring effect is reflected. The influences of the self-efficacy and self-restoring effects that differ by the user are expressed by the parameter value θ^{u}ₓ.

Here, it is assumed that an observed value y^{u}ₜ of the target behavior at time t for each user is generated stochastically from the following binomial distribution P(y^{u}ₜ) based on motivation.

$$[ Math . 6 ]$$

$$P ( {y}_{t}^{u} ) = {σ ( {m}_{t}^{u} \vert {θ}_{σ}^{u} )}^{{y}_{t}^{u}} {( 1 - σ ( {m}_{t}^{u} \vert {θ}_{σ}^{u} ) )}^{1 - {y}_{t}^{u}} \qquad ( 3 )$$

Here, σ(·|θ^{u}_{σ}) is a nonnegative function satisfying the following condition, and has a parameter value θ^{u}_{σ}.

$$[ Math . 7 ]$$

$$0 < σ ( \cdot \vert {θ}_{σ}^{u} ) < 1 \qquad ( 4 )$$

The above-defined behavior model has a parameter value specific to the user expressed below (hereinafter referred to as θ^{u}).

$$[ Math . 8 ]$$

$${θ}^{u} = ( {β}^{u} , {θ}_{x}^{u} , {θ}_{h}^{u} , {θ}_{e}^{u} , {θ}_{σ}^{u} ) \qquad ( 5 )$$

The parameter value is estimated by the parameter estimation unit 112 based on a maximum likelihood estimation method expressed by the following formula.

$$[ Math . 9 ]$$

$${\overline{θ}}^{u} = arg {max}_{{θ}^{u}} {L}^{u} ( {θ}^{u} ) , {L}^{u} ( {θ}^{u} ) = {\prod }_{t = 0}^{{T}^{u}} P ( {y}_{t}^{u} ) \qquad ( 6 )$$

That is, the parameter estimation unit 112 estimates the parameter value θ^{u} of the behavior model for each user based on the behavior history data.

In step ST103, the parameter estimation unit 112 stores the estimated parameter value in the parameter storage unit 132.

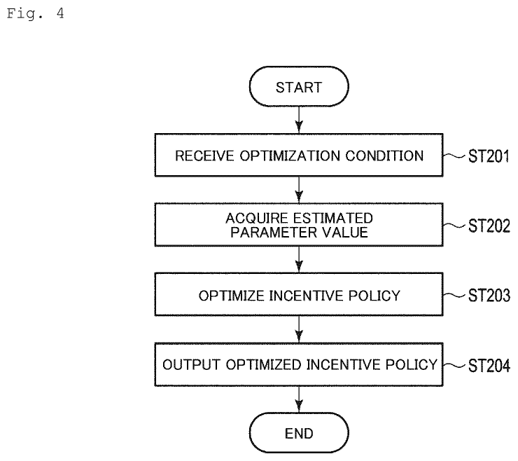

FIG. 4 is a flowchart illustrating an example of an operation of calculating the optimal incentive policy of the information processing apparatus 1.

The control unit 11 of the information processing apparatus 1 reads and executes a program stored in the storage unit 13, and thus the operation of the flowchart is implemented.

The operation may start at any timing. For example, the operation may automatically start at each constant time and may automatically start using an operation of the owner of the information processing apparatus 1 as a trigger.

In step ST201, the condition acquisition unit 1112 acquires the condition from the input apparatus 2 via the input/output interface 12. For example, the user may input the condition to the input apparatus 2. Alternatively, the behavior history data acquisition unit 1111 may acquire the condition stored in an external server or the like via the input/output interface 12. The condition acquisition unit 1112 stores the acquired condition in the acquired data storage unit 131. The condition acquisition unit 1112 may output a signal indicating that the condition has been acquired to the optimization unit 113. Alternatively, the condition acquisition unit 1112 may output the condition to the optimization unit 113.

The condition includes a length of a target period (hereinafter referred to as Ξ^{u}), a total budget used for incentives in the target period (hereinafter referred to as B), a sequence of explanatory variables for the target period (hereinafter referred to as the following formula), and an objective function of evaluating optimization of the incentive policy (hereinafter referred to as Z).

$$\{ {e}_{t}^{u} \} ≡ ( {e}_{1}^{u} , {e}_{2}^{u} , … , {e}_{{Ξ}^{u}}^{u} ) \qquad [ Math . 10 ]$$

The above formula represents the sequence of explanatory variables for the target period. Here, an incentive policy for maximizing an expected value of the objective function is defined as an optimum incentive policy. The objective function Z may be, for example, a total number of successes of the target behavior for the target period, a sum of the total number of successes and a weight of a paid total incentive amount, or the like.

$$Z = {\sum }_{t = 1}^{T} {y}_{t}^{u} \qquad [ Math . 11 ]$$

The above formula represents the total number of accesses of the target behavior.

$$Z = {\sum }_{t = 1}^{T} {y}_{t}^{u} ( 1 - {ca}_{t}^{u} ) \qquad [ Math . 12 ]$$

The above formula represents the sum of the total number of successes and a weight of a paid total incentive amount. Here, c is a weight. The objective function Z is not limited to the above-described example.

In step ST202, the optimization unit 113 acquires the parameter value stored in a parameter storage unit 132. The optimization unit 113 receiving a signal indicating that the condition has been acquired acquires the parameter value stored in the parameter storage unit 132. Further, the optimization unit 113 acquires the condition stored in the acquired data storage unit 131. When the condition is directly received from the condition acquisition unit 1112, the optimization unit 113 may use the received condition.

In step ST203, the optimization unit 113 calculates the optimal incentive policy. The optimization unit 113 calculates the optimal incentive policy that is based on a reinforcement learning theory for each user u∈{1, 2, . . . , U}. Here, the incentive policy is defined as a function f^{u} that receives time t, the success stop x^{u}ₜ at time t, a usable remaining budget (hereinafter referred to as but) I the total budget at time t, and the explanatory variable e^{u}ₜ at time t as an input and outputs an incentive amount a^{u}ₜ presented at time t, and is expressed in the following formula.

$$[ Math . 13 ]$$

$${a}_{t}^{u} = {f}^{u} ( t , {x}_{t}^{u} , {b}_{t}^{u} , {e}_{t}^{u} ) \qquad ( 7 )$$

Further, the optimum incentive policy is a policy for maximizing an expected value of the objective function Z, as described above, and is expressed by the following formula.

$$[ Math . 14 ]$$

$${f}^{u *} = arg {max}_{{f}^{u}} E [ Z ] \qquad ( 8 )$$

Here, E[⋅] indicates the expected value. A state V^{u}ₜ at time t is defined as follows in the behavior model described in step ST102 described with reference to FIG. 3.

$$[ Math . 15 ]$$

$${V}_{t}^{u} = ( t , {x}_{t}^{u} , {b}_{t}^{u} , {e}_{t}^{u} , {y}_{t}^{u} )$$

If the state is defined as the above formula, the state V^{u}ₜ follows the following Markov decision process (hereinafter referred to as MDP). Here, the state V^{u}ₜ at time t has the success stock, the remaining budget, the explanatory variable, an observed value of a behavior as functions.
At time t, the observed value y^{u}ₜ of the target behavior when the incentive amount a^{u}ₜ is presented is generated stochastically according to Formula (3). Here, it is assumed that the value which can be taken by the incentive amount a^{u}ₜ is equal to or less than the remaining budget.
After the generation of the observed value y^{u}ₜ of the target behavior, a state transition from time t to time (t+1) is executed at probability of 1.

$$[ Math . 16 ]$$

$$\begin{matrix}t \to & t + 1 \\ {e}_{t}^{u} \to & {e}_{t + 1}^{u} \\ {x}_{t}^{u} \to & ( 1 - {β}^{u} ) {x}_{t}^{u} + {β}^{u} {y}_{t}^{u} \\ {b}_{t}^{u} \to & {b}_{t}^{u} - {y}_{t}^{u} {a}_{t}^{u}\end{matrix} \qquad ( 9 )$$

In MDP, a policy for maximizing the expected value of the objective function Z is obtained by solving, for example, a Bellman optimality equation. For example, an incentive policy f* satisfying Formula (8) can be obtained by solving the Bellman optimality equation. Here, a scheme of solving the Bellman optimality equation may be, for example, a Deep Q network or the like using a neural network. The Deep Q network using this neural network is disclosed, for example, in Non Patent Literature “Volodymyr Mnih et al., “Playing Atari with Deep Reinforcement Learning”, arXiv, 2013” or the like.

An optimized incentive policy f^{u}* is defined using the following behavior value function approximated by a neural network, for example, when a Bellman optimality equation is solved using a Deep Q network.

$$Q ( {V}_{t}^{u} , {a}_{t}^{u} ) \qquad [ Math . 17 ]$$

$$[ Math . 18 ]$$

$${f}^{u *} = arg {max}_{{a}_{t}^{u}} Q ( {V}_{t}^{u} , {a}_{t}^{u} ) \qquad ( 10 )$$

The optimization unit 113 stores the calculated optimal incentive policy in the optimization incentive policy storage unit 133. The optimization unit 113 may output a signal indicating that the optimal incentive policy is stored in the optimization incentive policy storage unit 133 to the output control unit 114. Alternatively, the optimization unit 113 may directly output the optimal incentive policy to the output control unit 114.

In step ST204, the output control unit 114 outputs the optimal incentive policy. When a signal indicating that the optimal incentive policy is stored in the optimization incentive policy storage unit 133 is received from the optimization unit 113, the output control unit 114 acquires the optimal incentive policy f^{u}* from the optimization incentive policy storage unit 133. Alternatively, when the optimal incentive policy f^{u}* is directly received from the optimization unit 113, the output control unit 114 may use the received optimal incentive policy. The output control unit 114 outputs the optimal incentive policy f^{u}* to the output apparatus 3 via the input/output interface 12. Here, the optimal incentive policy f^{u}* output to the output apparatus 3 as expressed by Formula (10) is a parameter value of the neural network model.

In this way, by inputting the behavior history data and the condition to the input apparatus 2, the user can acquire the optimal incentive policy f^{u}* from the output apparatus 3.

### (Operational Effects)

According to the embodiments, it is possible to specify, for each individual, an incentive policy that is most cost-effective in order to maintain a target behavior. A business operator can support achievement of a target behavior for each user at lower cost by using a cost-effective incentive policy. Accordingly, the business operator can expand profits or set low service usage fees.

### Other Embodiments

The present invention is not limited to the above-described embodiments. For example, in the present invention, an example in which the Bellman optimality equation is solved using the Deep Q network has been described, but the present invention is not limited thereto For example, the Bellman optimality equation may be solved by approximation using a multilayer perceptron. That is, a general method can be applied as the method of solving the Bellman optimality equation.

Furthermore, the scheme described in the foregoing embodiment can also be stored as programs (software means) which can be executed by a computer in, for example, a storage medium such as a magnetic disk (a floppy (registered trademark) disk, a hard disk, or the like), an optical disc (a CD-ROM, a DVD, an MO, or the like), and a semiconductor memory (a ROM, a RAM, a flash memory, or the like) to be transferred and distributed via communication media. The program stored on a medium side also includes a setting program configuring software means (including not only an execution program but also a table and a data structure) executed by a computer in the computer. A computer which implement the present apparatus reads a program stored in a storage medium, and if necessary, constructs software means using the setting program, and performs the above-described processing by controlling an operation of the software means. The storage medium mentioned in the present specification is not limited to a storage medium for distribution and includes a storage medium such as a magnetic disk or a semiconductor memory provided in a computer or a device connected via a network.

In short, the present invention is not limited to the foregoing embodiment and can be variously modified in an implementation stage without departing from the gist and scope of the present invention. The embodiments may be appropriately combined as appropriately as possible. In such a case, combined effects can be obtained.

Furthermore, the foregoing embodiments include inventions in various stages, and various inventions may be extracted through appropriate combinations of the plurality of disclosed constituent elements.

### REFERENCE SIGNS LIST

1 Information processing apparatus
11 Control unit
111 Acquisition unit
1111 Behavior history data acquisition unit
1112 Condition acquisition unit
112 Parameter estimation unit
113 Optimization unit
114 Output control unit
12 Input/output interface
13 Storage unit
131 Acquired data storage unit
132 Parameter storage unit
133 Optimization incentive policy storage unit
2 Input apparatus
3 Output apparatus

1. An information processing apparatus comprising:
circuitry configured to
acquire behavior history data and a condition for optimizing an incentive policy for each of users;
estimate a parameter value of a behavior model for each user based on the behavior history data, the behavior model having a success stock indicating a psychological accumulated amount of past success experiences as an internal variable;
calculate an optimal incentive policy for each user based on the estimated parameter value and the condition; and
output the optimal incentive policy.

2. The information processing apparatus according to claim 1,
wherein the behavior history data includes a series of incentive amounts at each observation time for each user,
the circuitry further configured to estimate a parameter value of a behavior model for each user, the behavior model that receives the series of incentive amounts as inputs and an outputs an achievement for a target behavior for each user.

3. The information processing apparatus according to claim 2,
wherein the behavior history data further includes an observed value of a target behavior of evaluating success or failure of a behavior aimed at each observation time for each user and an explanatory variable that is information having an influence on the behavior aimed at each observation time for each user, and
wherein the behavior model for each user further includes a motivation for determining whether the target behavior is successful as the internal variable, and the motivation is determined by a function representing an influence on the success stock for each user, a function representing sensitivity to the incentive amount for each user, and a function representing an influence of each user on the explanatory variable.

4. The information processing apparatus according to claim 3, wherein the function representing the influence on the success stock for each user is one of a monotonically increasing function, a function increasing until a predetermined value and changing to a decrease after the predetermined value, and a function decreasing to a predetermined value and changing to an increase after the predetermined value.

5. The information processing apparatus according to claim 3, wherein the behavior model for each user is stochastically generated from a binomial distribution represented by a nonnegative function which has the motivation as an internal variable and in which a behavior at each observation time for each user is larger than 0 and smaller than 1, and the parameter estimation unit estimates a parameter value of the behavior model for each user based on a maximum likelihood estimation method, and
wherein the condition includes of evaluating a length of the target period, a total budget used for incentives for the target period, a sequence of the explanatory variables for the target period, and optimization of an incentive policy, the incentive policy is a function that receives a time, the success stock at the time, a remaining budget of the total budget available in the incentive policy, and the explanatory variable as inputs and outputs an incentive amount presented at the time, and the optimal incentive policy is an incentive policy for maximizing an expected value of the target function.

6. The information processing apparatus according to claim 5, wherein states at the time is defined as the success stock, the remaining budget, the explanatory variable, and the observed value of the behavior,
the observed value of the target behavior when the incentive amount is presented at the time is stochastically generated in accordance with the binomial distribution,
a value which can be taken by the incentive amount is equal to or less than the remaining budget, and
the circuitry further configured to calculate the optimal incentive policy by solving a Bellman optimality equation in a Markov decision process in which transitions from the time to a next time at a probability of 1.

7. An information processing method executed by an information processing apparatus including a processor, the method comprising:
acquiring, by the processor, behavior history data for each user;
acquiring, by the processor, a condition when an incentive policy is optimized;
estimating, by the processor, a parameter value of a behavior model for each user based on the behavior history data, the behavior model having a success stock indicating a psychological accumulated amount of past success experiences as an internal variable;
calculating an optimal incentive policy for each user based on the estimated parameter value and the condition; and
outputting, by the process, the optimal incentive policy.

8. A non-transitory computer readable storage medium storing a computer program which is executed by a processor included in an information processing apparatus to provide the steps of:
acquiring behavior history data and a condition for optimizing an incentive policy for each of users;
estimating a parameter value of a behavior model for each user based on the behavior history data, the behavior model having a success stock indicating a psychological accumulated amount of past success experiences as an internal variable;
calculating an optimal incentive policy for each user based on the estimated parameter value and the condition; and
outputting the optimal incentive policy.

9. The information processing apparatus according to claim 4, wherein the behavior model for each user is stochastically generated from a binomial distribution represented by a nonnegative function which has the motivation as an internal variable and in which a behavior at each observation time for each user is larger than 0 and smaller than 1, and the parameter estimation unit estimates a parameter value of the behavior model for each user based on a maximum likelihood estimation method, and
wherein the condition includes of evaluating a length of the target period, a total budget used for incentives for the target period, a sequence of the explanatory variables for the target period, and optimization of an incentive policy, the incentive policy is a function that receives a time, the success stock at the time, a remaining budget of the total budget available in the incentive policy, and the explanatory variable as inputs and outputs an incentive amount presented at the time, and the optimal incentive policy is an incentive policy for maximizing an expected value of the target function.

10. The information processing apparatus according to claim 9, wherein states at the time is defined as the success stock, the remaining budget, the explanatory variable, and the observed value of the behavior,
the observed value of the target behavior when the incentive amount is presented at the time is stochastically generated in accordance with the binomial distribution,
a value which can be taken by the incentive amount is equal to or less than the remaining budget, and
the circuitry is further configured to calculate the optimal incentive policy by solving a Bellman optimality equation in a Markov decision process in which transitions from the time to a next time at a probability of 1.
